(19) United States
(12) Patent Application Publication
(10) Pub. No.: US 2017/0267702 A1
(43) Pub. Date: Sep. 21, 2017

(54) Method for Making Alkylhalosilanes

(71) Applicant: SCM Metal Products, Inc., Research Triangle Park, NC (US)

(72) Inventor: Mark Kromer BARR, Cary, NC (US)

(73) Assignee: SCM Metal Products, Inc., Research Triangle Park, NC (US)

(21) Appl. No.: 15/500,191

(22) PCT Filed: Jul. 18, 2015
(86) PCT No.: PCT/US2015/041042

§ 371 Date: Jan. 30, 2017

Related U.S. Application Data
(60) Provisional application No. 62/031,922, filed on Aug. 1, 2014.

(51) Int. Cl. C07F 7/16; B01J 23/06; B01J 35/00; B01J 23/80; B01J 23/72; B01J 35/02

(52) U.S. Cl. CPC C07F 7/16; B01J 23/72; B01J 35/026; B01J 35/0006; B01J 23/80; B01J 23/06

(57) ABSTRACT

Disclosed is a method for making alkylhalosilanes from an alkyl halide and silicon in the presence of the catalyst package comprising metallic aluminum dispersed throughout a copper catalyst. Also disclosed in some embodiments is a catalyst package comprising metallic aluminum dispersed throughout a copper catalyst. In some embodiments the catalyst package comprises a copper catalyst comprised of a metallic copper/cuprous oxide/cupric oxide granular particulate catalyst and a copper-aluminum alloy.

### CROSS-REFERENCE TO RELATED APPLICATIONS

This application is an international patent application filed in accordance with the patent cooperation treaty. This international application claims priority benefit of U.S. Provisional Patent Application Ser. No. 62/031,922 filed Aug. 1, 2014, and entitled “Method for Making Alkylhalosilanes.” The disclosure of the aforementioned Provisional Patent Application Ser. No. 62/031,922 is hereby incorporated by reference in its entirety.

### BACKGROUND

Alkylhalosilanes have many significant industrial applications such as in the preparation of oils, gums, or coatings and as a starting material in the manufacture of silicones. There is a need for increased reaction rate in the preparation of alkylhalosilanes while at the same time maintaining or improving the selectivity for desirable alkylhalosilanes. More efficient methods of preparation of valuable alkylhalosilanes reduce production costs and facilitate production processes.

### SUMMARY

The present inventor has recognized that significant and unexpected improvements in reaction rate and selectivity in preparing alkylhalosilanes can be achieved when a catalyst package comprising metallic aluminum which is incorporated onto the copper portion of a copper catalyst is used. The catalyst package as described in various embodiments comprises granular particles with metallic aluminum dispersed throughout the copper catalyst particles. In some embodiments, the metallic aluminum is in the form of a copper-aluminum alloy.

A catalyst package, in accordance with some embodiments described herein, comprises a well-dispersed metallic copper-aluminum alloy onto a metallic copper/cuprous oxide/cupric oxide granular particulate catalyst. A catalyst package, in accordance with some embodiments described herein, comprises granular particles of a copper catalyst with aluminum metal or copper-aluminum alloy dispersed throughout the catalyst package granular particles. Provided herein, in some embodiments, is a catalyst package comprising granular particles comprised of metallic aluminum highly dispersed onto a mixed copper species substrate. Provided herein, in some embodiments, is a catalyst package comprising granular particles comprised of a copper-aluminum alloy highly dispersed onto a mixed copper species substrate, or catalyst. In some embodiments the copper species substrate, or catalyst, is comprised of Cu, Cu₂O, CuO, or combinations thereof. In some embodiments, the copper species substrate, or catalyst, is comprised of Cu, Cu₂O, and CuO.

In some embodiments, the copper species substrate, or copper catalyst, is combined with aluminum to provide a catalyst package with copper catalyst and aluminum distributed throughout the particles of the catalyst package particles. In some embodiments, the copper species substrate, or catalyst, is combined with a copper-aluminum alloy to provide a catalyst package with copper catalyst and copper-aluminum alloy distributed throughout the particles of the catalyst package particles. The aluminum and copper/aluminum alloy can be described as catalyst activity promoters. In accordance with embodiments described herein, metallic aluminum is dispersed onto the copper species substrate to provide granular particles with metallic aluminum dispersed throughout the catalyst package particles. In accordance with preferred embodiments, metallic aluminum as part of a copper-aluminum alloy is dispersed onto the copper species substrate to provide a catalyst package of granular particles with aluminum-copper alloy dispersed throughout the catalyst package particles.

Provided herein, in some embodiments, is a method for making alkylhalosilanes by reacting an alkyl halide with silicon powder in the presence of a catalyst package comprising well-dispersed metallic copper-aluminum alloy on a metallic copper/cuprous oxide/cupric oxide granular particulate catalyst.

In some embodiments provided herein is a method for making alkylhalosilanes using a catalyst package comprising granular particles comprised of metallic aluminum, as part of a copper-aluminum alloy, highly dispersed onto a mixed copper species substrate. In various embodiments provided herein, the catalyst package is comprised of granular particles comprising a copper substrate and a copper-aluminum alloy wherein the copper-aluminum alloy is dispersed throughout the granular catalyst package particles.

As used herein, the terms “copper substrate”, “metallic copper catalyst”, and “copper catalyst” are used interchangeably. These terms refer to a catalyst comprising copper and in various embodiments other ingredients. In some embodiments, the copper catalyst comprises copper, Cu₂O, CuO, and combinations thereof. In some embodiments, the copper catalyst can be a copper flake catalyst. In some embodiments, the copper catalyst can be a copper-tin-zinc alloy flake catalyst. In some embodiments, the copper catalyst comprises cuprous chloride.

In some embodiments, described herein is a method for making alkylhalosilanes, comprising, reacting silicon and an alkyl halide in the presence of a catalyst package comprising aluminum dispersed throughout a copper catalyst particle. In some embodiments, the aluminum dispersed throughout the copper catalyst particle is a copper-aluminum alloy. In some embodiments, the copper-aluminum alloy is an about 50% Cu/50% Al alloy. In some embodiments, the alkyl halide is methyl chloride. In some embodiments, the copper catalyst is comprised of metallic copper (Cu), cuprous oxide (Cu₂O) and cupric oxide (CuO). In some embodiments, the copper catalyst is comprised of about 10% metallic copper (Cu), about 55% cuprous oxide (Cu₂O) and about 35% cupric oxide (CuO) and aluminum is about 0.9% of the catalyst package. In some embodiments, the copper catalyst is comprised of copper selected from metallic copper (Cu), cuprous oxide (Cu₂O), cupric oxide (CuO) and combinations thereof. In some embodiments, the catalyst package is a granular particle.

In some embodiments, described herein is a method for making methylchlorosilanes, comprising reacting silicon and methyl chloride in the presence of a catalyst package comprising aluminum dispersed throughout a copper catalyst particle. In some embodiments, the copper catalyst is comprised of metallic copper (Cu), cuprous oxide (Cu₂O) and cupric oxide (CuO). In some embodiments, the copper catalyst is comprised of about 10% metallic copper (Cu), about 55% cuprous oxide (Cu₂O) and about 35% cupric oxide (CuO) and aluminum is about 0.9% of the catalyst package. In some embodiments, the aluminum dispersed throughout a copper catalyst particle a copper-aluminum alloy. In some embodiments, the copper-aluminum alloy is an about 50% Cu/50% Al alloy. In some embodiments, the copper catalyst is comprised of copper selected from metallic copper (Cu), cuprous oxide (Cu₂O), cupric oxide (CuO) and combinations thereof. In some embodiments, the methylchlorosilane is dimethyldichlorosilane. In some embodiments, the catalyst package is a granular particle.

In some embodiments, described herein is a catalyst package comprising metallic aluminum and a copper catalyst particle, wherein the metallic aluminum is dispersed on the copper catalyst. In some embodiments, the catalyst package is a granular particle and the metallic aluminum is dispersed throughout the granular particle. In some embodiments, the copper catalyst particle is comprised of metallic copper (Cu), cuprous oxide (Cu₂O), and cupric oxide (CO). In some embodiments, the metallic aluminum is a copper-aluminum alloy. In some embodiments, the copper-aluminum alloy is a 50% Cu/50% Al alloy. In some embodiments of the catalyst package, the copper catalyst is comprised of about 10% metallic copper (Cu), about 55% cuprous oxide (Cu₂O) and about 35% cupric oxide (CuO) and aluminum is about 0.9% of the catalyst package. In some embodiment, the catalyst package further comprises a catalyst promoter selected from copper salts, copper halides, phosphorous, zinc, tin, ZnO, ZnCl₂, SnCl2, and combinations thereof.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 shows a representation of the incremental activity of catalysts prepared by different methods including a method using a catalyst package disclosed herein as the SCM Process—AlCu—CuxO Catalyst Powder;

FIG. 2 shows the incremental selectivity for dimethyldichlorosilane using catalysts prepared by different methods;

FIG. 3 shows the incremental selectivity for trimethylchlorosilane of catalyst prepared by differed methods;

FIG. 4 shows the cumulative selectivity for dimethyldichlorosilane of catalysts prepared by different methods.

### DETAILED DESCRIPTION

It has been found, in various embodiments as described herein that significant improvements in reaction rate and selectivity are achieved when metallic aluminum is incorporated into the copper portion of a catalyst package. A novel catalyst for manufacturing methylchlorosilanes and a method for making such catalysts is disclosed. The preparation method disperses metallic aluminum throughout a Cu/Cu₂O/CuO catalyst particle. This novel preparation method improves process reaction rate and selectivity.

A “catalyst package” as used herein refers to a catalyst for preparing alkylhalosilanes in which a copper catalyst and aluminum metal are combined in a particle. The aluminum in a catalyst package as used herein can be in the form of a copper-aluminum alloy. The catalyst package in some embodiments comprises metallic aluminum dispersed throughout a copper (Cu)/cuprous oxide (Cu₂O)/cupric oxide (CuO) catalyst particle. The catalyst package, catalyst, as taught by this application unexpectedly provides improved reaction rate and selectivity. The catalyst package as provided herein significantly provides improved reaction rate and selectivity for dimethyldichlorosilane.

The reaction to prepare alkylhalosilanes generally proceeds by reacting silicon and an alkyl halide in the presence of a copper catalyst. Various promoters of this reaction include Cu/Al alloy, zinc, tin, and Cu/P alloy. In some embodiments, additional promoters can be included in the catalyst package as described herein.

In some embodiments, provided herein is a method for making alkylhalosilanes by effective reaction between an alkyl halide, such as methyl chloride, and powdered silicon in the presence of a catalyst package comprising copper, zinc, tin, and aluminum.

Embodiments of the present invention provide an improved process for the production of alkylhalosilanes using a higher activity catalyst (i.e., higher reaction rate), a catalyst package, than is achieved by the separate addition of pure aluminum powder or by the separate addition of aluminum alloys such as Cu/Al alloy. The catalyst package in accordance with various embodiments of the invention comprises metallic aluminum dispersed throughout a Cu/Cu₂O/CuO catalyst particle.

In some embodiments, a catalyst package in accordance with the present invention can be prepared by co-milling a copper/cuprous oxide/cupric oxide powder with fine metallic tin, fine metallic copper and a fine 50%/50% Cu/Al alloy powder to manufacture a powder with a d50 in the 0.05-3 μm range. During this process the copper/cuprous oxide/cupric oxide particles are comminuted and the ductile, malleable metals (tin, copper, Cu/Al alloy) are highly dispersed over the much more brittle copper/cuprous oxide/cupric oxide particles to prepare the catalyst package in accordance with some embodiments of the invention. In some preferred embodiments a 1:1 Cu:Al alloy is used in the catalyst package. It is understood by persons of skill in the art that a range of Cu/Al alloy ratios will be effective.

In preparation of the catalyst package in accordance with various embodiments described herein, coarse copper/cuprous oxide/cupric oxide particles and Cu/Al powder, with optionally tin metal and additional copper metal, are comminuted contemporaneously. The copper/cuprous oxide/cupric oxide particles are brittle and shatter during comminution. The ductile, malleable metals are believed to be flaked, folded and broken into very thin, small particles that are ground onto/into the brittle copper/cuprous oxide/cupric oxide particles during the comminution process such that the metallic particles are highly dispersed onto/into the copper/cuprous oxide/cupric oxide particles and no longer distinct separate particles.

In making alkylhalosilanes in accordance with various embodiments described herein, the reaction will typically be operated in a fluidized bed or a stirred bed reactor at between about 295 and about 300° C., although under certain circumstances the reaction can operate at between about 265 and about 340° C. Alkyl halide gases and in particular methyl chloride is reacted with metallic silicon powder and the catalyst package as described herein in various embodiments.

In one exemplary embodiment, the method disclosed herein can use a fluidized bed reactor operating at about 300° C. with methyl chloride gas. The catalyst package comprises copper comprising about 10% metallic copper, about 55% cuprous oxide, and about 35% cupric oxide. In some embodiments, the active aluminum portion, a catalyst promoter, of the catalyst package as described in various embodiments of the invention is about 0.9% metallic aluminum. Persons of skill in the art recognize this as an illustration of a copper catalyst in accordance with some embodiments of the invention and the viable ranges or the copper catalyst components are much wider.

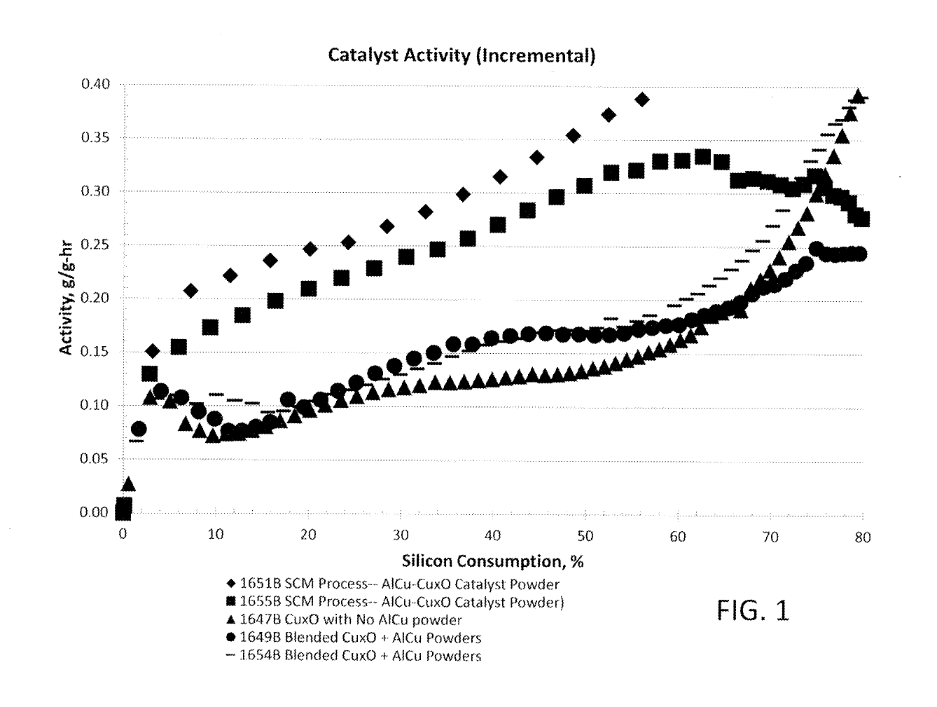

Further examples and description of embodiments of the invention are described as the “SCM process” in the following and FIGS. 1 to 4.

### Examples

The following examples illustrate various embodiments of the invention. These examples are merely illustrative and should not be construed as limiting the scope of the invention.

Materials: All materials used are available for purchase from a variety of sources. Zinc powder used was purchased from New Jersey Zinc Corp., which is currently Horsehead Corporation.

Tin powder was manufactured by SCM Metal Products, Research Triangle Park, N.C., in accordance with methods understood by persons of skill in the art. Tin powder is also available from ACuPowder.

All reaction tests used commercially available chemical grade silicon purchased from Elkem Metals Company, Alloy, W.Va. The silicon was ball milled and blended to provide a uniform and consistent silicon feed. The major impurities, as provided by the manufacturer and confirmed by an outside testing laboratory, are 0.32% Fe, 0.14% Al, and 0.004% Ca.

The particle size distribution of the test silicon is shown in Table I below.

TABLE 1
Silicon Particle Size Distribution

| % (wt/wt) | Size (μm) |
|---|---|
| 10 | 116 |
| 25 | 97 |
| 50 | 70 |
| 75 | 32 |
| 90 | 5.9 |

The Cu/Cu₂O/CuO feed material was produced by SCM Metals. Comminuting processes were carried out in the SCM laboratory. Fluidized bed reactors are constructed in accordance with the required specifications by procedures well known by persons of skill in the art.

All reaction tests and catalyst preparations used commercially available materials. “High Purity Grade” methyl chloride was obtained from Machine & Welding Supply Company.

The commercial halosilanes catalyst, X-151-XA, was manufactured by SCM Metal Products. The copper-aluminum alloy, CuAl50 AS<0.1 mm, was purchased from Ecka Granules Germany GmbH, Eckastr. 1, 91235 Velden, Germany.

### Reaction Test Equipment and Chemical Reactants

Reaction tests were conducted in a stirred bed reactor. The reactor used was constructed of low carbon stainless steel, 28 inches high and 2 inches internal diameter. The reactor and reaction mass was heated using a fluidized bed sand bath and the contact mass was continuously stirred to insure uniform temperature throughout the contact mass and homogeneous contact between the contact mass and methyl chloride.

For all of the examples, the reaction conditions were as follows: 100.00 grams ground silicon, 120 sccm CH₃Cl gas, and a reaction temperature of 300° C. The catalyst and appropriate additives (tin, zinc, copper-aluminum alloy powder, as appropriate) were admixed with the silicon before addition to the reactor. The crude product composition was measured using an Agilent gas chromatograph (Model 7890A) equipped with a flame ionization detector (FID) and a thermal conductivity (TCD) detector. The chromatograph column was a 30% OV-210 Chromosorb PAW-DMCS 80/100 12 ft.×⅛′ stainless steel column. The reaction rate and crude production activity were determined by using 3.00 sccm nitrogen gas as an inert marker gas mixed into the methyl chloride gas feed stream prior to introduction into the reactor. Mass flow controllers on the methyl chloride gas and on the nitrogen gas insure a uniform and constant flow rate for both gases.

### General Catalyst Preparation Method

A mixed copper oxide material was oxidized on a belt furnace at 900-1000° F. with a residence time of approximately 30 minutes to produce a mixed copper oxide particulate material. The composition was approximately 50% cuprous oxide, 45% cupric oxide, and 5% free copper. This mixed copper oxide material was comminuted as described in U.S. Pat. No. 4,520,130 to prepare catalyst systems. U.S. Pat. No. 4,520,130 is hereby incorporated herein by reference. The catalyst prepared in this manner commercially is called X-151-XA and sold by SCM Metal Products. The catalyst in the examples described herein was prepared in accordance with these processes. Other preparation methods for copper catalysts preparation are known in the art such as, for example, the preparation as described in U.S. Pat. No. 4,218,387.

### Test Catalyst: CuₓO

Silicon powder (100.00 g), the X-151-XA catalyst (3.00 g), and zinc powder (0.300 g) were admixed together and added to the stirred bed reactor under a methyl chloride gas flow. A gas chromatographic analysis of the gases coming from the reactor was taken after the contact mass was added to the reactor as the reactor was heated to 300° C. Gas chromatographic analysis data were collected every hour throughout the duration of the reaction.

### Test Catalyst: Blended CuₓO+AlCu Powders

Silicon powder (100.00 g), the X-151-XA catalyst (3.00 g), zinc powder (0.300 g), and the copper-aluminum alloy were admixed together and added to the stirred bed reactor under a methyl chloride gas flow. A gas chromatographic analysis of the gases coming from the reactor was taken after the contact mass was added to the reactor as the reactor was heated to 300° C. Gas chromatographic analysis data were collected every hour throughout the duration of the reaction.

### Test Catalyst: SCM Process—AlCu—CuₓO Catalyst Package

Catalyst preparation: The AlCu—CuₓO catalyst package was prepared by a process as disclosed in U.S. Pat. No. 4,520,130 but with the inclusion of a copper-alloy to produce a catalyst package in accordance with some embodiments of the invention disclosed herein. U.S. Pat. No. 4,520,130 is hereby incorporated herein by reference. The coarse mixed copper oxide material (4.0 lbs.) described in the General Catalyst Preparation section was admixed with tin (2.36 g), copper-aluminum alloy (36.29 g), and copper powder (163.30 g) and comminuted for one hour in a two gallon stirred attrition mill containing 50 lbs. 0.125 in. milling media and 5.04 g stearic acid lubricant.

### Reactor Test

Silicon powder (100.00 g), the AlCu—CuₓO catalyst package described above (3.030 g), and zinc powder (0.300 g) were admixed together and added to the stirred bed reactor under a methyl chloride gas flow. A gas chromatographic analysis of the gases coming from the reactor was taken after the contact mass was added to the reactor as the reactor was heated to 300° C. Gas chromatographic analysis data were collected every hour throughout the duration of the reaction.

In FIG. 1 the incremental activity of catalysts prepared by different methods is shown.

“SCM Process—AlCu—CuₓO Catalyst Powder” is an example of the catalyst package as described herein in various embodiments. AlCu in the catalyst package as prepared by the methods described herein acts as a catalyst activity promoter. “CuₓO with No AlCu” is an example of a catalyst with no AlCu powder addition. “Blended CuₓO+CuAl Powders” is a catalyst prepared by a method inferior to the disclosed method, but with the same CuAl content as the SCM Process catalyst. These results demonstrate that CuAl acts as a catalyst activity promoter, and the manufacturing process described in various embodiments of the invention produces a significantly higher activity. A catalyst package, as disclosed herein in various embodiments, is a system, comprising a copper catalyst, also referred to as a copper substrate, and a catalyst promoter, in various embodiments, comprising aluminum.

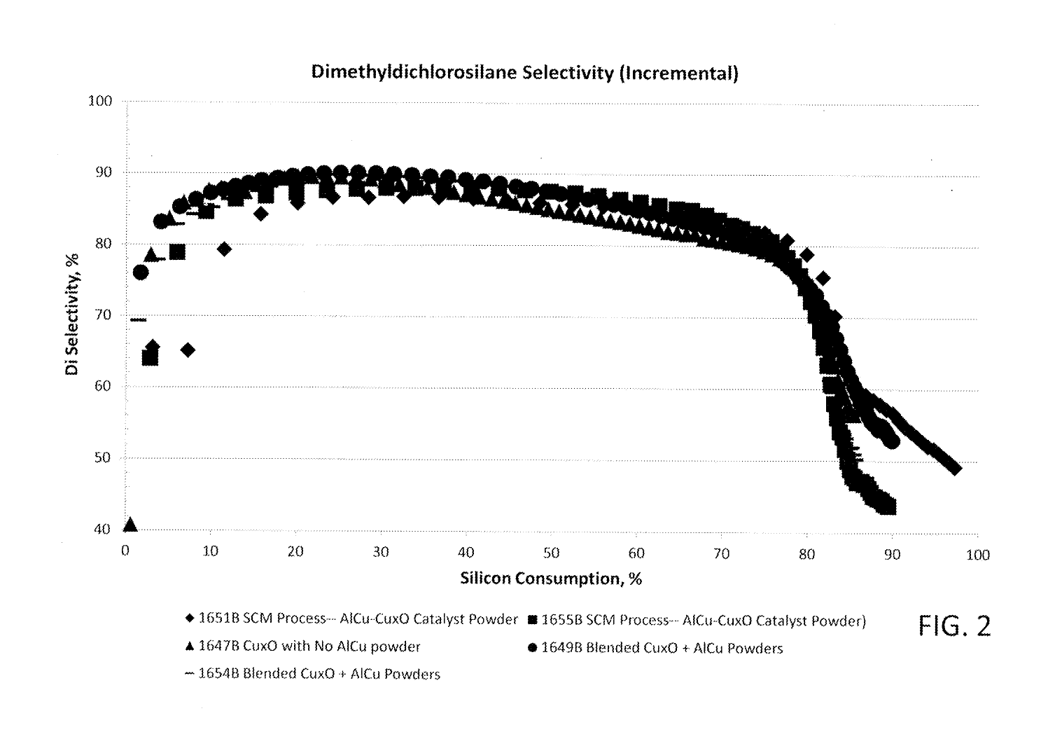

FIG. 2 shows the incremental selectivity for dimethyldichlorosilane of catalysts prepared by different methods. “SCM Process—AlCu—CuₓO Catalyst Powder” is the catalyst package as prepared by the methods disclosed herein. “CuₓO with No AlCu” is a copper catalyst with no AlCu powder addition. “Blended CuₓO+CuAl Powders” is a catalyst prepared by a method inferior to the disclosed method, but with the same CuAl content as the SCM Process catalyst.

These results demonstrate that CuAl only slightly decreases incremental selectivity to dimethyldichlorosilane early in the reaction and increases incremental selectivity later in the reaction.

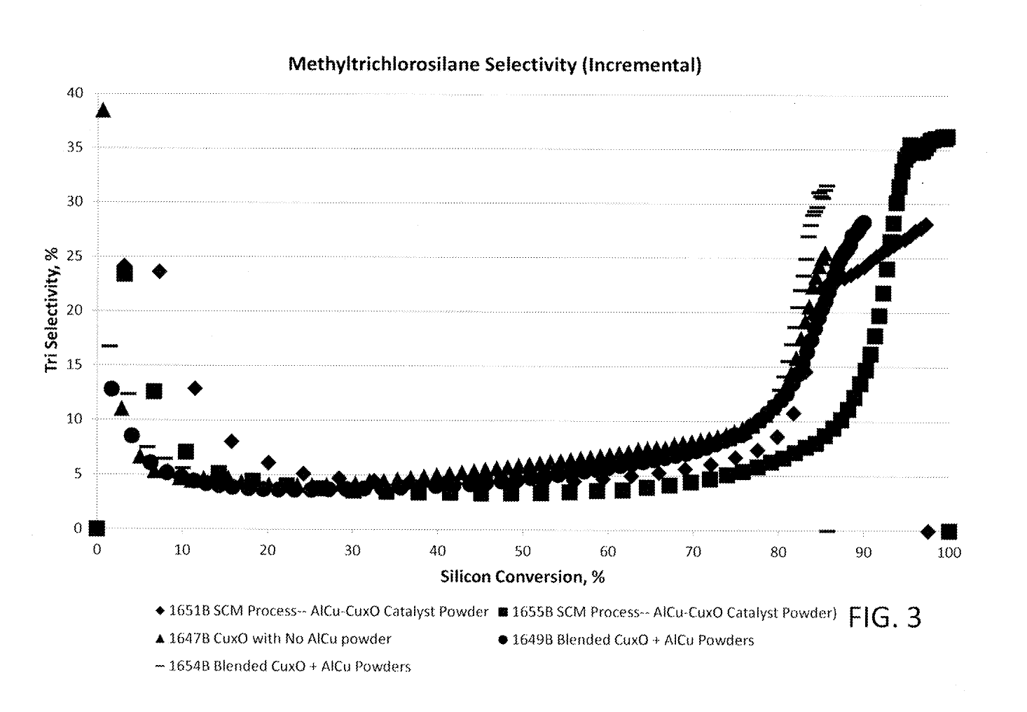

FIG. 3 shows the incremental selectivity for trimethylchlorosilane of catalysts prepared by different methods is shown. “SCM Process—AlCu—CuₓO Catalyst Powder” is the catalyst packaged as prepared by methods disclosed herein. “CuₓO with No AlCu” is a catalyst with no AlCu powder addition. “Blended CuₓO+CuAl Powders” is a catalyst prepared by a method inferior to the disclosed method, but with the same CuAl content as the SCM Process catalyst. These results demonstrate that CuAl does not significantly change incremental selectivity to trimethylchlorosilane, a major reaction by-product. Trimethylchlorosilane is considered a lower valued product.

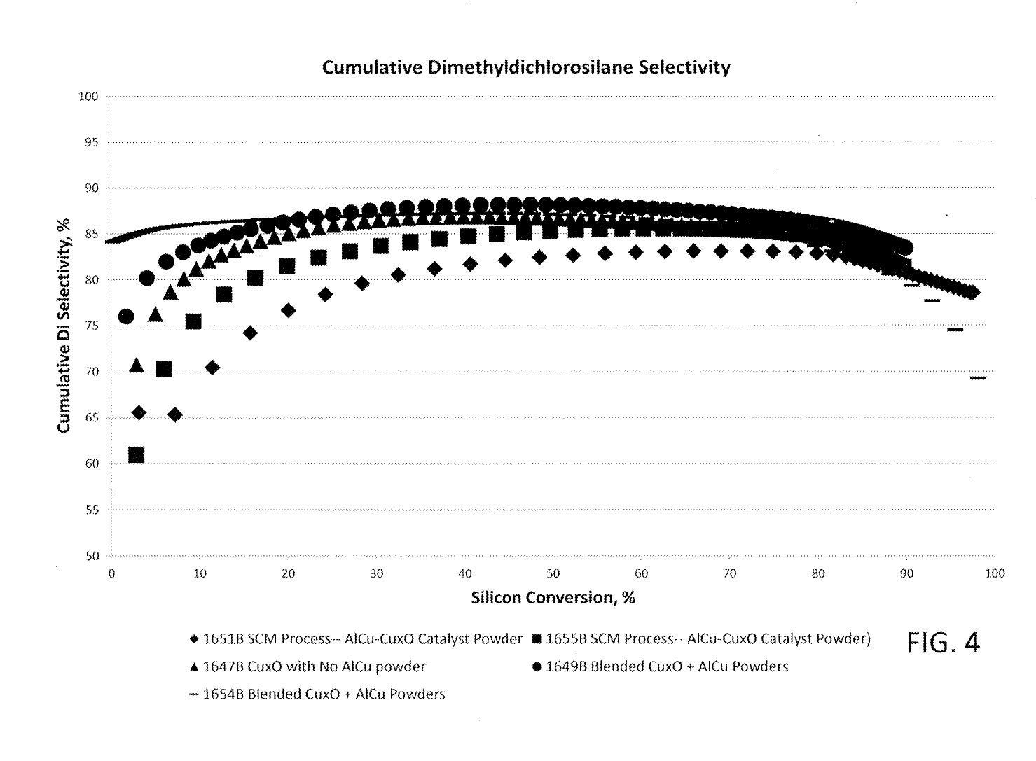

FIG. 4 shows the cumulative selectivity for dimethyldichlorosilane of catalysts prepared by different methods. “SCM Process—AlCu—CuₓO Catalyst Powder” is the catalyst package as prepared by methods disclosed herein. “CuₓO with No AlCu” is a catalyst with no AlCu powder addition. “Blended CuₓO+CuAl Powders” is a catalyst prepared by a method inferior to the disclosed method, but with the same CuAl content as the SCM Process catalyst. These results demonstrate that CuAl does not significantly change the overall cumulative selectivity to dimethyldichlorosilane when reacted to completion.

1-23. (canceled)

24. A method for making alkylhalosilanes, comprising,
reacting silicon and an alkyl halide in the presence of a catalyst package comprising aluminum dispersed throughout a copper catalyst particle.

25. The method of claim 24, wherein the aluminum dispersed throughout the copper catalyst particle is a copper-aluminum alloy.

26. The method of claim 25, wherein the copper-aluminum alloy is an about 50% Cu/50% Al alloy.

27. The method of claim 24, wherein the alkyl halide is methyl chloride.

28. The method of claim 24, wherein the copper catalyst is comprised of metallic copper (Cu), cuprous oxide (Cu₂0) and cupric oxide (CuO).

29. The method of claim 28, wherein the copper catalyst is comprised of about 10% metallic copper (Cu), about 55% cuprous oxide (Cu₂0) and about 35% cupric oxide (CuO) and aluminum is about 0.9% of the catalyst package.

30. The method of claim 24, wherein the copper catalyst is comprised of copper selected from metallic copper (Cu), cuprous oxide (Cu 20), cupric oxide (CuO) and combinations thereof.

31. The method of claim 24, wherein the catalyst package is a granular particle.

32. A method for making methylchlorosilanes, comprising reacting silicon and methyl chloride in the presence of a catalyst package comprising aluminum dispersed throughout a copper catalyst particle.

33. The method of claim 32, wherein the copper catalyst is comprised of metallic copper (Cu), cuprous oxide (Cu₂0) and cupric oxide (CuO).

34. The method of claim 33, wherein the copper catalyst is comprised of about 10% metallic copper (Cu), about 55% cuprous oxide (Cu₂0) and about 35% cupric oxide (CuO) and aluminum is about 0.9% of the catalyst package.

35. The method of claim 33, wherein the aluminum dispersed throughout the copper catalyst is a copper-aluminum alloy.

36. The method of claim 35, wherein the copper-aluminum alloy is an about 50% Cu/50% Al alloy.

37. The method of claim 32, wherein the copper catalyst is comprised of copper selected from metallic copper (Cu), cuprous oxide (Cu₂0), cupric oxide (CuO) and combinations thereof.

38. The method of claim 32, wherein the methylchlorosilane is dimethyldichlorosilane.

39. The method of claim 32, wherein the catalyst package is a granular particle.

40. A catalyst package comprising metallic aluminum and a copper catalyst particle, wherein the metallic aluminum is dispersed on the copper catalyst.

41. The catalyst package of claim 40, wherein the catalyst package is a granular particle and the metallic aluminum is dispersed throughout the granular particle.

42. The catalyst package of claim 40, wherein the copper catalyst particle is comprised of metallic copper (Cu), cuprous oxide (Cu₂0), and cupric oxide (CO).

43. The catalyst package of claim 40, wherein the metallic aluminum is a copper-aluminum alloy.

44. The catalyst package of claim 43, wherein the copper-aluminum alloy is a 50% Cu/50% Al alloy.

45. The catalyst package of claim 42, wherein the copper catalyst is comprised of about 10% metallic copper (Cu), about 55 cuprous oxide (Cu₂0) and about 35% cupric oxide (CuO) and aluminum is about 0.9% of the catalyst package.

46. The catalyst package of claim 40, further comprising a catalyst promoter selected from copper salts, copper halides, phosphorous, zinc, tin, ZnO, ZnCh, SnCh, and combinations thereof.
